(19) United States
(12) Patent Application Publication
(10) Pub. No.: US 2026/0260284 A1
(43) Pub. Date: Sep. 3, 2026

(54) NATURAL LANGUAGE PROCESSING TO OBTAIN GENERALIZED PARAMETERS FOR PROMPTING GENERATIVE MODEL TO GENERATE ITEM REPLACEMENTS

(71) Applicant: Maplebear Inc., San Francisco, CA (US)

(72) Inventors: Brent Scheibelhut, Toronto (CA); Mark Oberemk, Toronto (CA); Naval Shah, Toronto (CA); Charles Wesley, San Diego, CA (US)

(21) Appl. No.: 19/067,253

(22) Filed: Feb. 28, 2025

(51) Int. Cl. G06Q 30/0601; G06F 40/40

(52) U.S. Cl. CPC G06Q 30/0635; G06F 40/40

(57) ABSTRACT

The online system suggests replacement items to a user when an ordered item is unavailable. To improve the replacement suggestions for a given user, the online system obtains a set of generalized parameters for the user, where a generalized parameter provides guidance for replacing multiple different types of items. When the online system is fulfilling an order and identifies that an item in the order is unavailable, the online system uses a machine-learning model to score various candidate replacement items. The candidate replacement items can be obtained by prompting a generative model (e.g., language model) with one or more generalized parameters for the user that are relevant to the item. The generative model can be further prompted to adjust the scores of the candidate replacement items. Based on the adjusted scores, the online system selects a replacement item, and then presents the selected replacement item to the user.

### BACKGROUND

Online systems allow their users to interact with items, e.g., by placing online orders for the items. However, not every item that a user orders is in stock at their source location (e.g., retail store). To provide adequate replacements for out-of-stock items, an online system learns, over a certain period of time, user's implicit preferences for replacements of various out-of-stock items. However, these data points (or training data) are related to specific items that replace specific out-of-stock items. Additionally, users of the online system can also provide explicit replacement preferences, such as by selecting an item to purchase if their preferred item is unavailable. However, these explicit replacement preferences are limited to specific items and often to a specific source (e.g., retailer or brand). Even if a user orders an item that is very similar to an out-of-stock item, no explicit replacement is effectively defined. Also, there is no effective way for a user to provide broader replacement heuristics on a large variety of items. This is because it is not practical for users to express generalized preferences about a large variety of items that are available for ordering via the online system.

Therefore, there is a technical problem of how to efficiently and at a large scale as required by the online system infer user's general preferences for replacement items. Specifically, the reliance on item-specific replacement data, whether implicit or explicit, leads to inefficiencies in training and applying machine-learning models used to suggest replacements. This item-specific approach restricts the ability of machine-learning models to generalize across different item categories, resulting in suboptimal replacement suggestions, increased computational resource requirements, and limited scalability. Additionally, traditional machine-learning methods for generating replacement suggestions are often rule-based, lacking the flexibility to incorporate broader user preferences or dynamic contextual data, such as real-time inventory levels or environmental factors. Addressing these challenges requires a more advanced system architecture capable of inferring and using global replacement preferences to improve the performance of replacement models, enabling the system to adapt dynamically to complex replacement scenarios.

### SUMMARY

Embodiments of the present disclosure are directed to using natural language processing and a generative model (e.g., language model or machine-learning model) to infer generalized parameters (e.g., general features, or general preferences) for a user of an online system and identify item replacements for the user based on the inferred generalized parameters.

In accordance with one or more aspects of the disclosure, the online system obtains a set of generalized parameters for a user of the online system, each generalized parameter from the set of generalized parameters related to a preference of the user that applies across multiple corresponding types of items. The online system receives, via a network and from a device associated with the user, a request for one or more items of an order. Responsive to the request, the online system determines that a replacement is needed for an item of the one or more items. Responsive to identifying that the replacement is needed, the online system identifies, using information about the user and information about the item, a first set of one or more candidate replacement items for replacing the item. Responsive to identifying that the replacement is needed, the online system generates a first prompt for input into a generative machine-learning model, the first prompt including one or more generalized parameters from the set of generalized parameters that are relevant to the item. The online system requests the generative machine-learning model to generate, based on the first prompt, a first response including a second set of one or more candidate replacement items for replacing the item. The online system combines the first set of one or more candidate replacement items and the second set of one or more candidate replacement items to generate a set of candidate replacement items. The online system generates, using information about past ordering of items by the user, a score for each candidate replacement item from the set of candidate replacement items that is indicative of a likelihood of the user converting on each candidate replacement item. The online system generates a second prompt for input into the generative machine-learning model, the second prompt including information about each candidate replacement item from the set of candidate replacement items, the score for each candidate replacement item, and the one or more generalized parameters. The online system requests the generative machine-learning model to generate, based on the second prompt, a second response including an adjusted score for each candidate replacement item from the set of candidate replacement items, the adjusted score for each candidate replacement item representing an adjusted value of the score for each candidate replacement item. The online system selects, using the adjusted score for each candidate replacement item, a replacement item from the set of candidate replacement items. The online system generates, using information about the replacement item, a user interface signal. The online system sends, via the network, the user interface signal to the device associated with the user, wherein the sending the user interface signal causes the device associated with the user to display a user interface with the information about the replacement item and a user interface element, and wherein selection of the user interface element triggers addition of the replacement item to the order instead of the item.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3A illustrates an example architectural flow diagram of using a generative machine-learning model (e.g., language model) to infer generalized parameters for a user of an online system, in accordance with one or more embodiments.

FIG. 3B illustrates an example architectural flow diagram of using a generative machine-learning model (e.g., language model) to identify item replacements for a user of an online system based on inferred generalized parameters for the user, in accordance with one or more embodiments.

FIG. 4 is a flowchart for a method of using a generative machine-learning model (e.g., language model) to infer generalized parameters for a user of an online system and identify item replacements for the user based on the inferred generalized parameters, in accordance with one or more embodiments.

### DETAILED DESCRIPTION

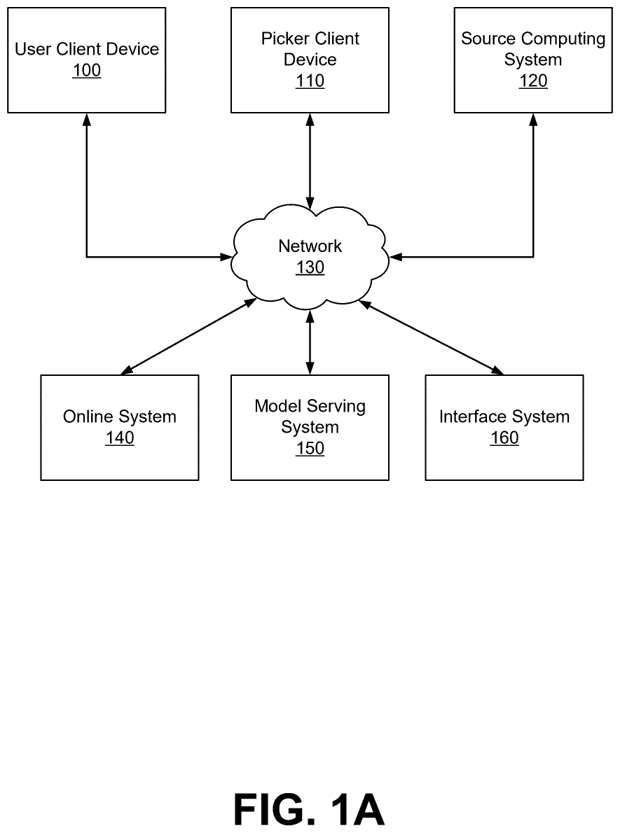

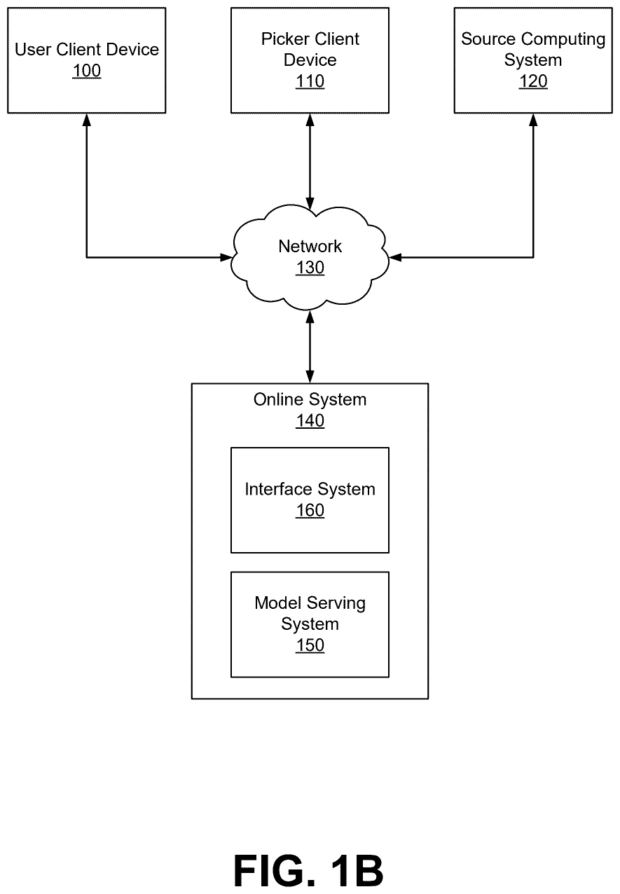

FIG. 1A illustrates an example system environment for an online system 140, in accordance with one or more embodiments. The system environment illustrated in FIG. 1A includes a user client device 100, a picker client device 110, a source computing system 120, a network 130, an online system 140, a model serving system 150, and an interface system 160. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1A, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with an agent that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker (also referred to herein as a servicing agent, or agent) services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

The online system 140 suggests replacement items to users when an ordered item is out of stock. To improve the replacement suggestions for a given user of the online system 140, the online system 140 obtains one or more user's general (or global) replacement preferences, where a general replacement preference provides guidance for replacing multiple different types of items. A general replacement preference (or global replacement preference) is a user's replacement preference that encompasses multiple types of items, i.e., the general replacement preference is not related only to a replacement of a specific item. General preferences may be inferred or explicit. When the online system 140 is fulfilling an order and finds that an item in the order is out of stock, the online system 140 uses a replacement machine-learning model to score various candidate replacement items. The candidate replacement items may be obtained, in part, by prompting a generative machine-learning model (e.g., language model) with the general replacement preferences that are relevant to the out-of-stock item. The generative machine-learning model may be further prompted to adjust the scores of the candidate replacement items, or select, using the general replacement preferences, one or more replacement items from the scored candidate replacement items. The online system 140 then presents the one or more selected replacement items to the user via a user interface of the user client device 100. Hence, the online system 140 infers a general replacement preference about a user's preferred replacement strategy and utilizes the generative machine-learning model to apply the user's general replacement preference for replacing specific items.

The online system 140 presented herein utilizes the generative machine-learning model for collecting and structuring the general replacement preferences so these general replacement preferences can be fed into the personalized replacement machine-learning model. In this manner, users can obtain better replacements without having to specify every last item replacement option. Additionally, these general replacement options may not be limited to one-to-one replacements. For example, a user of the online system 140 can specify more nuanced replacements, such as “Replace blueberries with blackberries on Tuesday, but with raspberries on Thursday”. Furthermore, the general replacement preferences may also factor a state of an item into account. The general replacement preferences inferred in this manner can improve the user's conversion experience.

The model serving system 150 receives requests from the online system 140 to perform tasks using machine-learning models. The tasks include, but are not limited to, natural language processing (NLP) tasks, audio processing tasks, image processing tasks, video processing tasks, and the like. In one or more embodiments, the machine-learning models deployed by the model serving system 150 are language models configured to perform one or more NLP tasks. The NLP tasks include, but are not limited to, text generation, query processing, machine translation, chatbots, and the like. In one or more embodiments, a language model of the model serving system 150 is configured as a transformer neural network architecture (i.e., a transformer model). Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learning model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learning model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM, the LLM is able to perform various tasks and synthesize and formulate output responses based on information extracted from the training data.

In one or more embodiments, when the machine-learning model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In one or more other embodiments, the transformer architecture may have an encoder-decoder architecture and includes a set of encoders coupled to a set of decoders. An encoder or decoder may include one or more attention operations.

While an LLM with a transformer-based architecture is described in one or more embodiments, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

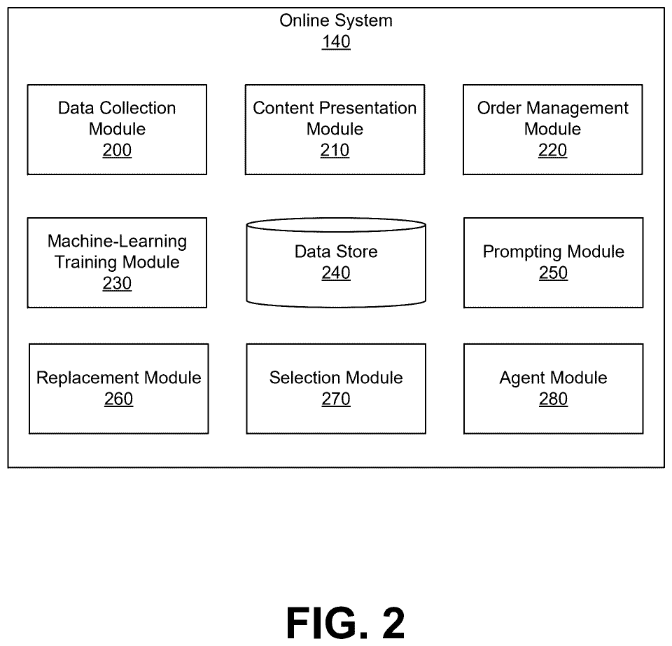

The online system 140 may first employ an LLM of the model serving system 150 to infer a user's general replacement preference. The online system 140 may prepare (e.g., via a prompting module 250 in FIG. 2) a first prompt for input to the LLM. The first prompt may include information about the user's historical conversions. The LLM may generate a first response to the first prompt based on execution of the machine-learning model using the first prompt. The first response may include information about the user's general replacement preference. The online system 140 may import the first response from the model serving system 150 and use the first response as an input signal to the replacement machine-learning model that is trained to identify and score candidate replacement items for a given user of the online system 140.

The online system 140 may further use the first response as an input signal to the LLM to identify additional candidate replacement items for the given user. Hence, the online system 140 may also employ the LLM to infer the candidate replacement items personalized for the user. The online system 140 may prepare (e.g., via a prompting module 250 in FIG. 2) a second prompt for input to the LLM. The second prompt may include information about the one or more user's general replacement preferences. The LLM may generate a second response to the second prompt based on execution of the machine-learning model using the second prompt. The second response may include information about candidate replacement items for the user including an adjusted score for each candidate replacement item. The online system 140 may import the second response from the model serving system 150 and use the second response as an input signal to select one or more candidate replacement items for presentation to the user via a user interface of the user client device 100.

In one or more embodiments, the task for the model serving system 150 is based on knowledge of the online system 140 that is fed to the machine-learning model of the model serving system 150, rather than relying on general knowledge encoded in the model weights of the model. Thus, one objective may be to perform various types of queries on the external data in order to perform any task that the machine-learning model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 150 and synthesizes a response to the query on the external data. While the online system 140 can generate a prompt using the external data as context, often times, the amount of information in the external data exceeds prompt size limitations configured by the machine-learning language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a user client device 100, a picker client device 110, a source computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140. The online system 140 is described in further detail below with regards to FIG. 2.

FIG. 2 illustrates an example system architecture for the online system 140, in accordance with some embodiments. The system architecture illustrated in FIG. 2 includes a data collection module 200, a content presentation module 210, an order management module 220, a machine-learning training module 230, a data store 240, a prompting module 250, a replacement module 260, a selection module 270, and an agent module 280. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from the source computing system 120, the picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In one or more embodiments, the order management module 220 determines when to offer an order to a picker based on a delivery timeframe requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In one or more embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In one or more embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In one or more embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

With respect to the machine-learning models hosted by the model serving system 150, the machine-learning models may already be trained by a separate entity from the entity responsible for the online system 140. In one or more other embodiments, when the model serving system 150 is included in the online system 140, the machine-learning training module 230 may further train parameters of the machine-learning model based on data specific to the online system 140 stored in the data store 240. As an example, the machine-learning training module 230 may obtain a pre-trained transformer language model and further fine tune the parameters of the transformer language model using training data stored in the data store 240. The machine-learning training module 230 may provide the transformer language model to the model serving system 150 for deployment.

The online system 140 identifies one or more user's general (or global) replacement preferences by obtaining explicit information about the user's general replacement preference(s) or by inferring the user's general replacement preference(s). In one or more embodiments, the data collection module 200 receives, via the network 130 and from the user client device 100, information about the user's general replacement preference(s) as the user explicitly states one or more general replacement preferences, e.g., in a replacement chat on a user interface of the user client device 100. In one or more other embodiments, the prompting module 250 prompts a generative machine-learning model (or a language model, such as an LLM of the model serving system 150) to infer user's general replacement preference(s), where a prompt for input into the generative machine-learning model includes information about the user's one or more specific replacement choices. In such cases, the content presentation module 210 may use information about the inferred general replacement preference(s) to generate a user interface signal that is sent, via the network 130, to the user client device 100 causing the user client device 100 to display a user interface with a prompt for the user to confirm the inferred general replacement preference(s).

The online system 140 may utilize the user's global preference(s) for identifying a replacement for an item that is currently out of stock. The order management module 220 may first determine that a replacement is needed for a particular item in an order. In such cases, the prompting module 250 may prompt the generative machine-learning model to identify any general replacement preferences that are relevant to the missing item to be replaced. To find candidate replacements for the missing item, the replacement module 260 may apply the replacement flow to find candidate replacement items. In such cases, the replacement module 260 may retrieve, from a user catalog database (e.g., stored at the data store 240) and using an identifier of the user, information about the user including information about one or more specific features for the user, each of the one or more specific features related to a preference of the user for a specific type of item. The replacement module 260 may further retrieve, from an item catalog database (e.g., stored at the data store 240) and using an identifier of the item, information about the item including information about a taxonomy of the item (i.e., classification of the item or type of the item). Then, the replacement module 260 may identify, using the information about the user and the information about the item, candidate replacement items for replacing the missing item.

In one or more embodiments, the prompting module 250 generates a prompt for input to the generative machine-learning model, the prompt including information about user's general replacement preference(s) and/or contextual data, e.g., information about the user's current inventory, user's past conversion data, information about current day and time, information about current weather, etc. The prompting module 250 may request the generative machine-learning model to generate, using the prompt, a response including one or more additional candidate replacement items, i.e., one or more candidate replacement items not previously identified by the replacement machine-learning model.

The replacement module 260 may combine candidate replacement items identified by the replacement machine-learning model and additional candidate replacement items identified by the generative machine-learning model to generate a common set of candidate replacement items. Upon generating the set of candidate replacement items, the replacement module 260 may score and rank each candidate replacement item from the set of candidate replacement items.

To generate a score for each candidate replacement item, the replacement module 260 may access a replacement machine-learning model of the online system 140 that is trained to predict a likelihood of the user converting on each candidate replacement item from the set of candidate replacement items. The replacement module 260 may deploy the replacement machine-learning model to run a machine-learning algorithm to input signals to output a score for each candidate replacement item from the set of candidate replacement items, where the score is indicative of the likelihood of the user converting on each candidate replacement item. The score may be a value between 0 and 1, where a lower value of the score is indicative of a lower likelihood of the user converting on each candidate replacement item, and a higher value of the score is indicative of a higher likelihood of the user converting on each candidate replacement item. A set of parameters for the replacement machine-learning model may be stored at one or more non-transitory computer-readable media of the replacement module 260. Alternatively, the set of parameters for the replacement machine-learning model may be stored at one or more non-transitory computer-readable media of the data store 240.

The replacement machine-learning model may leverage a variety of input signals to score each candidate replacement item from the set of candidate replacement items. In providing the input signals to the replacement machine-learning model, the replacement module 260 may provide content of a current order placed at the online system 140, user's chat data (e.g., user's free text responses) in relation to past replacements, information about user's specific (or structured) preferences, general replacement preferences previously inferred by the generative machine-learning model, some other data, or some combination thereof. Data with information about the content of the current order may be communicated in real time via the network 130 to the online system 140 and the replacement module 260. Additionally, the replacement module 260 may retrieve information about the chat data and the user's specific preferences from a user catalog database (e.g., stored at the data store 240).

The machine-learning training module 230 may perform initial training of the replacement machine-learning model using training data. The machine-learning training module 230 may generate the training data that include information about replacements that users of the online system 140 conducted while ordering items via the online system 140. The machine-learning training module 230 may retrieve the information about users'past replacements from a user catalog database (e.g., stored at the data store 240). Each label included in the training data may include an identifier of an original missing item and an identifier of a replacement item. The machine-learning training module 230 may train the replacement machine-learning model using the training data to generate initial values for the set of parameters of the replacement machine-learning model.

The prompting module 250 may request the generative machine-learning model to adjust, using a first prompt, scores of candidate replacement items from the set of candidate replacement items. The prompting module 250 may generate the first prompt for input into the generative machine-learning model, the first prompt including each candidate replacement item from the set of candidate replacement items, a score of each candidate replacement item generated by the replacement machine-learning model, each relevant general replacement preference for the user, any other contextual data obtained by accessing one or more APIs (e.g., information about the user's inventory, user's past conversion data, information about current weather, etc.), and a request for the generative machine-learning model to adjust the score of each candidate replacement item.

Alternatively, the prompting module 250 may request the generative machine-learning model to select, using a second prompt, one of the candidate replacement items from the set of candidate replacement items. The prompting module 250 may generate the second prompt for input into the generative machine-learning model, the second prompt including each candidate replacement item from the set of candidate replacement items, a score of each candidate replacement item, each relevant general replacement preference for the user, any other relevant contextual data (e.g., time of day, day of the week, information about current weather, etc.), and a request for the generative machine-learning model to select one candidate replacement item from the from the set of candidate replacement items.

In one or more embodiments, given the second prompt, the generative machine-learning model selects a replacement item from the set of candidate replacement items that is preferred for, e.g., the current time instant and day of the week. In this manner, if the user wants a different replacement item for a missing item on Day 1 versus Day 2, the online system 140 integrating the replacement machine-learning model and the generative machine-learning model supports this conversion feature.

On the other hand, the online system 140 integrating the replacement machine-learning model and the generative machine-learning model presented herein supports the user's general preference about not replacing a specific item with any other item. For example, the user knows they go shopping on the weekend at the source Y; thus, if the user cannot get Item A from the source X on weekday because Item A is out of stock at the source X, the user will not be prompted with any item replacement candidates, and the user can just hold out on conversion until the user physically goes to the source Y on the weekend and convert on Item A then.

User's general replacement preferences are often tied to what a particular source carries, particularly when it comes to source brands. For example, a particular user will always take Brand A items over anything else, and if Item A of Brand A is missing at a source, the online system 140 integrating the replacement machine-learning model and the generative machine-learning model presented herein would not recommend to the user to convert on Item B of Brand B.

In one or more embodiments, a discussion can occur between a user and a picker (i.e., between the user client device 100 and the picker client device 110) when the generative machine-learning model needs to deduce a state of certain items, e.g., whether a specific produce item is fresh. In such cases, the generative machine-learning model may further receive, as part of a prompt, information about a current state of a candidate replacement item, e.g., as received from the picker client device 110 via the network 130. Additionally, the prompt that is input into the generative machine-learning model may include information about expiration dates of items. Then, using the prompt, the generative machine-learning model may infer a set of candidate items for replacing items that the user already has at home, but these items are currently out-of-stock at a user's preferred source and are about to expire. In such cases, the content presentation module 210 may generate, using the inferred set of candidate items, a user interface signal that is sent to the user client device 100 causing the user client device 100 to display a user interface with information about the expiration dates of at-home items and a prompt asking the user whether the user needs replacements for soon-to-expire items and displaying replacement recommendations.

The selection module 270 may use a score (e.g., adjusted by the generative machine-learning model) of each candidate replacement item from the set of candidate replacement items to rank the candidate replacement item and generate a ranked list of candidate replacement items. The selection module 270 may then select one or more replacement items from the ranked list of candidate replacement items for recommendation to the user. The selection module 270 may select, for recommendation to the user, a single replacement item having a highest adjusted score among all candidate replacement items in the ranked list of candidate replacement items. Alternatively, the selection module 270 may select, for recommendation to the user, a predetermined number of replacement items having the highest adjusted scores among candidate replacement items in the ranked list of candidate replacement items.

The content presentation module 210 may use information about the one or more selected replacement items to generate a user interface signal. The content presentation module 210 may send, via the network 130, the user interface signal to the user client device 100 (or the smart shopping cart), wherein sending the user interface signal causes the user client device 100 (or the smart shopping cart) to display a user interface with the information about the one or more selected replacement items, i.e., the one or more selected replacement items are suggested to the user for replacement of a missing item. The user may utilize a corresponding user interface element displayed at the user interface of the user client device 100 (or the smart shopping cart) to add one of the suggested replacement items to a current order (or to place one of the suggested replacement items to the smart shopping cart). Alternatively, the user may utilize a corresponding user interface element displayed at the user interface of the user client device 100 (or the smart shopping cart) to cancel any replacement item suggested to the user.

The machine-learning training module 230 and/or the model serving system 150 may collect feedback data with information about the user's response in relation to the one or more replacement items suggested to the user. The feedback data may be recorded at the user client device 100 or the smart shopping cart and communicated, via the network 130, to the online system 140, the model serving system 150, and the machine-learning training module 230. The feedback data may include information about whether the user accepted the suggested replacement item, chose another item that was not suggested for replacement, or just canceled the out-of-stock item. The machine-learning training module 230 may then re-train the replacement machine-learning model by updating the set of parameters of the replacement machine-learning model using the feedback data. Additionally, the model serving system 150 may retune the generative machine-learning model using the feedback data. By collecting feedback data with information about replacement responses from various users, the replacement machine-learning model and the generative machine-learning model may be re-trained and retuned, i.e., continuously improved over time. The improvement of the replacement machine-learning model and the generative machine-learning model may translate into maximizing a metric of user satisfaction on replacements. This metric may be tracked over time by tracking replacement approvals (e.g., a number of times users explicitly engage with “approve” user interface elements at user interfaces of the user client devices 100), by tracking order satisfactions (e.g., via chat responses from users), and/or by tracking appeasements due to “bad replacements” on items.

The online system 140 integrating the replacement machine-learning model and the generative machine-learning model presented herein provides for improved general (or global) replacements. The main result or function of the approach presented herein is to increase a rate of “good” orders, lower refunds and appeasements, and lower fulfillment time via powerful general replacements personalized to each user of the online system 140. The general replacements may span across taxonomy nodes and source locations but are personalized for each user.

The user may create the general replacements within their account settings by interacting (e.g., via the agent module 280) with an artificial intelligence agent (or language model agent) that would ask questions such as “What would you like us to do in the case item X is out of stock?”. The user may then respond via a user interface of the user client device 100 with natural language that the artificial intelligence agent (e.g., the agent module 280) could understand and map to preferences and replacements that are saved at the user catalog database. This may be achieved by the agent module 280 generating a question that is displayed at the user interface of the user client device 100 along with an item that is currently missing at a specific source location. For example, the agent module 280 may generate the question for displaying at the user interface of the user client device 100, such as “Would you like to replace this missing item by item Y based on your past purchases?” Alternatively, the agent module 280 may generate a user interface signal causing the user client device 100 to display a user interface with an input box that can ingest natural language and asking by voice whether the user would prefer a replacement for a missing item.

Mapping between a replacement prompt displayed at the user interface of the user client device 100 and a user's response to the prompt may not be one-to-one mapping. For example, an example response to a question of what the user would prefer the replacement to be for item X can be “If item X is out of stock on my Tuesday order, let's replace it with Item Y, but if item X is out of stock on my Friday order, let's replace it with Item Z. And if Item X is out of stock on Monday, let's refund it or try to add it to my Sunday Source Y order instead”. The user's general replacement preferences may also take into account the state of the item in question. For example, the user may respond via the user interface of the user client device 100 with “If the bananas are green, let's replace them with avocados instead”.

In one or more embodiments, the online system 140 integrating the replacement machine-learning model and the generative machine-learning model presented herein allows for voice agent interaction. In such cases, the agent module 280 may be configured to operate as an artificial intelligence voice agent. A prompt for input into the generative machine-learning model may be generated at least in part by the agent module 280 that converts a user's voice input (e.g., user's voice response provided via the user interface of the user client device 100) into a textual input that is then provided to the prompting module 250. Additionally, the agent module 280 may distill the tone and intention from the user's voice response. In such cases, the online system 140 provides for shopping experience that is conducted more through interaction with an artificial intelligence agent (e.g., the agent module 280) that selects certain items as replacements to missing items.

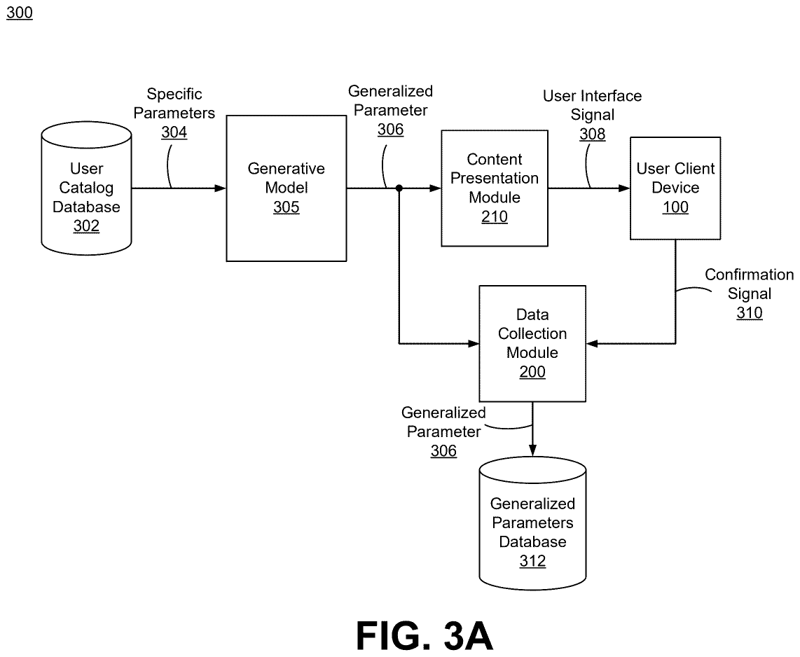

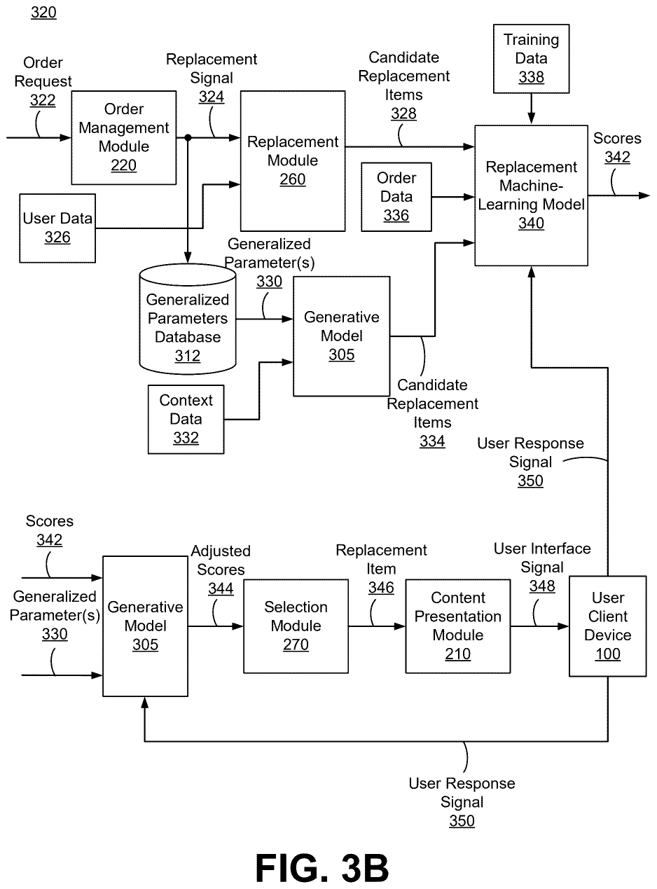

FIG. 3A illustrates an example architectural flow diagram 300 of using a generative machine-learning model 305 (e.g., language model or LLM) to infer generalized parameters (e.g., general features, or general replacement preferences) for a given user of the online system 140, in accordance with one or more embodiments. The prompting module 250 may first retrieve, from a user catalog database 302 (e.g., part of the data store 240) and using an identifier of the user, information about specific parameters 304 (e.g., specific features) for the user. Each specific parameter 304 may be related to a preference of the user for replacing a specific type of item. The prompting module 250 may then generate a prompt for input into the generative machine-learning model 305, the prompt including the specific parameters 304 and a request for the generative machine-learning model 305 to infer a generalized parameter 306 (e.g., general feature) for the user that represents a replacement preference for the user that applies across multiple types of items (e.g., across multiple taxonomy nodes). Based on the prompt, the generative machine-learning model 305 may generate a response that includes the generalized parameter 306. The generative machine-learning model 305 may pass information about the generalized parameter 306 to the content presentation module 210, as well as to the data collection module 200.

The content presentation module 210 may generate, using the information about the generalized parameter 306, a user interface signal 308. The content presentation module 210 may send, via the network 130, the user interface signal 308 to the user client device 100, wherein the sending the user interface signal 308 causes the user client device 100 to display a user interface with the information about the generalized parameter 306 and a notification request for the user to confirm the generalized parameter 306. Upon the user's confirmation of the generalized parameter 306 via a user interface element of the user interface of the user client device 100, the user client device 100 may generate a confirmation signal 310 indicating the user's confirmation of the generalized parameter 306.

The user client device 100 may communicate the confirmation signal 310 to the online system 140 via the network 130. The data collection module 200 (or some other module of the online system 140) may receive the confirmation signal 310. Responsive to receiving the confirmation signal 310, the data collection module 200 (or some other module of the online system 140) may include the generalized parameter 306 into a portion of a generalized parameters database 312 that is allocated to this specific user. The generalized parameters database 312 may include, for each user of a collection of users of the online system 140, a set of generalized parameters, where each generalized parameter from the set of generalized parameters is related to a replacement preference of each user that applies across multiple corresponding types of items. The generalized parameters database 312 may be part of the data store 240.

FIG. 3B illustrates an example architectural flow diagram 320 of using the generative machine-learning model to identify item replacements for a user of the online system 140 based on previously inferred generalized parameters for the user, in accordance with one or more embodiments. The process flow starts when the order management module 220 receives, via the network 130 from the user client device 100, an order request 322 indicating a user's request for one or more items of a current online order. Responsive to the order request 322, the order management module 220 may identify, using information collected from a source requested by the user, that a replacement is needed for an item of the current order as the item is not currently available at the source. In such cases, the order management module 220 may generate a replacement signal 324 with an indication that the replacement is needed, as well as with information about the missing item (e.g., information about a taxonomy of the missing item). The order management module 220 may pass the replacement signal 324 to the replacement module 260.

The replacement module 260 may utilize the replacement signal 324 with the information about the missing item and user data 326 to identify candidate replacement items 328 for replacing the missing item. The replacement module 260 may retrieve, from the user catalog database 302 and using an identifier of the user, the user data 326 including information about one or more specific parameters for the user (e.g., user's specific replacement preferences), user's order history, information about a current user's inventory (e.g., as obtained via the user client device 100 and/or via a user's smart refrigerator), information about expiration dates of items in the current user's inventory, some other user related information, or some combination thereof. The replacement module 260 may pass information about the candidate replacement items 328 to a replacement machine-learning model 340.

The prompting module 250 may retrieve, from the generalized parameters database 312, using the replacement signal 324 and the identifier of the user, one or more generalized parameters 330 that are relevant to the user and to the missing item. Additionally, the prompting module 250 may gather context data 332 including information about a time of day, information about day of the week, information about current weather, information about the current user's inventory, information about user's ordering history, some other contextual data, or some combination thereof. Based on a prompt input into the generative machine-learning model 305 including the one or more generalized parameters 330 and the context data 332, the generative machine-learning model 305 may identify candidate replacement items 334 for replacing the missing item.

Prior to running a machine-learning algorithm of the replacement machine-learning model 340, the online system 140 may perform (e.g., via the machine-learning training module 230) initial training of the replacement machine-learning model 340 using training data 338. The training data 338 may be generated (e.g., via the machine-learning training module 230) by retrieving, from the user catalog database 302, information about replacements that a set of users of the online system 140 conducted while ordering items via the online system 140. The machine-learning training module 230 may then generate labels for the training data 338, each label including an identifier of a missing item that was replaced and an identifier of a replacement item that a user from the set of users converted instead of the missing item. The machine-learning training module 230 may train, using the training data 338 including the labels, the replacement machine-learning model 340 to generate a set of initial values for a set of parameters of the replacement machine-learning model 340.

After the training process is completed, the online system 140 may provide a set of inputs to the replacement machine-learning model 340 (e.g., via the replacement module 260), such as the candidate replacement items 328, the candidate replacement items 334, and order data 336 with information about past conversions and replacements performed by the user. Some additional inputs not shown in FIG. 3B suitable for identifying a likelihood of the user's conversion of items may be further provided to the replacement machine-learning model 340. The replacement machine-learning model 340 may apply the machine-learning algorithm to the candidate replacement items 328, the candidate replacement items 334, and the order data 336 to generate scores 342, where each score 342 (e.g., value between 0 and 1) is indicative of a likelihood of the user converting on each of the candidate replacement items 328, 334. The replacement machine-learning model 340 may pass the scores 342 to the generative machine-learning model 305.

Based on the scores 342 and the one or more generalized parameters 330 for the user, the generative machine-learning model 305 may generate a response including adjusted scores 344 for the candidate replacement items 328, 334. Each adjusted score 344 may represent an adjusted value of the score 342 for each of the candidate replacement items 328, 334, e.g., adjusted based on the one or more generalized parameters 330 for the user. The generative machine-learning model 305 may pass the adjusted scores 344 to the selection module 270. Using the adjusted score 344 for each of the candidate replacement items 328, 334, the selection module 270 may select a replacement item 346, e.g., an item from the candidate replacement items 328, 334 having the highest adjusted score 344. The selection module 270 may pass information about the replacement item 346 to the content presentation module 210.

The content presentation module 210 may generate, using information about the replacement item 346, a user interface signal 348. The content presentation module 210 may send, via the network 130, the user interface signal 348 to the user client device 100, wherein the sending the user interface signal 348 causes the user client device 100 to display a user interface with the information about the replacement item 346 and a user interface element for use by the user to add the replacement item 346 to the current order instead of the missing item. Based on a user's response in relation to the replacement item 346 that was recommended to the user for replacing the missing item, the user client device 100 may generate and record a user response signal 350. The user response signal 350 may be indicative of the user's acceptance and conversion of the replacement item 346. Alternatively, the user response signal 350 may be indicative of the user's refusal to add the replacement item 346 to the current order. Alternatively, the user response signal 350 may be indicative of the user's refusal to add the replacement item 346 to the current order and of cancellation of the current order.

The online system 140 may receive (e.g., at the machine-learning training module 230 and/or the model serving system 150) the user response signal 350 from the user client device 100 via the network 130. The machine-learning training module 230 may utilize the user response signal 350 to re-train the replacement machine-learning model 340. By utilizing user response signals 350 provided by various users of the online system 140, the machine-learning training module 230 may update the set of parameters of the replacement machine-learning model 340 and continuously improve the machine-learning algorithm of the replacement machine-learning model 340. Additionally, the model serving system 150 may utilize the user response signal 350 to retune the generative machine-learning model 305. By utilizing user response signals 350 provided by various users of the online system 140, the model serving system 150 may update a set of parameters of the generative machine-learning model 305 and continuously improve the inference of the generative machine-learning model 305.

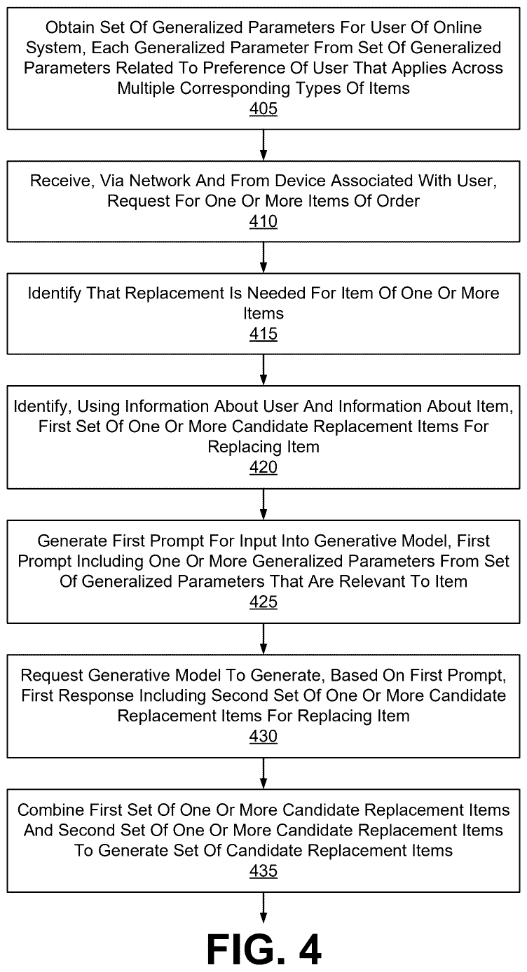

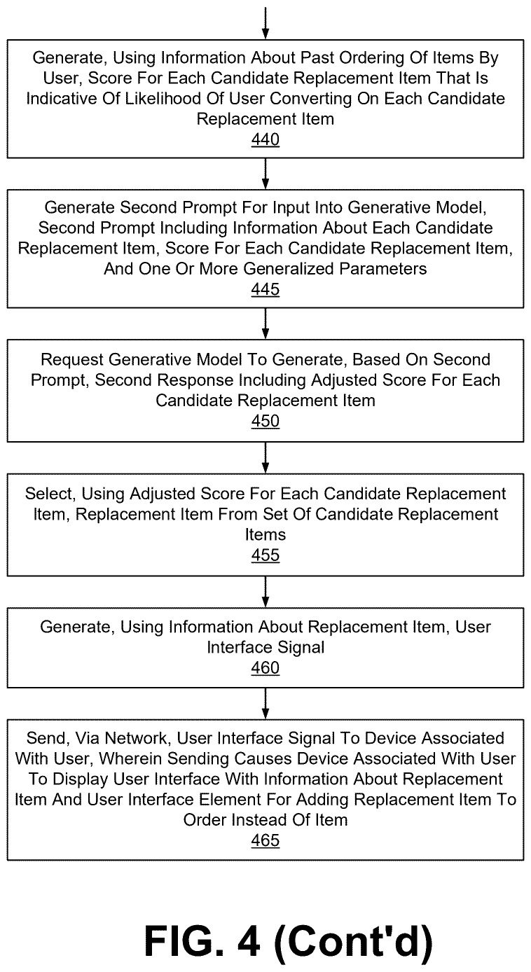

FIG. 4 is a flowchart for a method of using a generative machine-learning model (e.g., language model or LLM) to infer generalized parameters for a user of an online system and identify item replacements for the user based on the inferred generalized parameters, in accordance with one or more embodiments. Alternative embodiments may include more, fewer, or different steps from those illustrated in FIG. 4, and the steps may be performed in a different order from that illustrated in FIG. 4. These steps may be performed by an online system (e.g., the online system 140). Additionally, each of these steps may be performed automatically by the online system without human intervention.

The online system 140 obtains 405 (e.g., via the data collection module 200 and/or the prompting module 250) a set of generalized parameters (general features, or, more specific, general replacement preferences) for a user of the online system 140, each generalized parameter from the set of generalized parameters related to a preference of the user that applies across multiple corresponding types of items. The online system 140 may retrieve (e.g., via the prompting module 250), from a database of the online system 140 (e.g., the data store 240), information about one or more specific parameters (or one or more specific replacement preferences) for the user, each of the one or more specific parameters related to a preference of the user for a specific type of item. The online system 140 may generate (e.g., via the prompting module 250) a third prompt for input into the generative machine-learning model, the third prompt including the one or more specific parameters and a request to infer a generalized parameter for the user related to a preference of the user that applies across a plurality of types of items. The online system 140 may request (e.g., via the prompting module 250) the generative machine-learning model to generate, based on the third prompt, a third response including the general feature. The online system 140 may generate (e.g., via the content presentation module 210), using information about the generalized parameter, a second user interface signal. The online system 140 may send (e.g., via the content presentation module 210), via the network, the second user interface signal to the device associated with the user, wherein the sending the second user interface signal causes the device associated with the user to display the user interface with the information about the generalized parameter and a notification for the user to confirm the generalized parameter. The online system 140 may receive (e.g., via the data collection module 200), via the network and from the device associated with the user, a confirmation signal indicating confirmation by the user of the generalized parameter. Responsive to receiving the confirmation signal, the online system 140 may include (e.g., via the data collection module 200) the generalized parameter into the set of generalized parameters.

Alternatively or additionally, the online system 140 may receive (e.g., at the data collection module 200), via the network and from the device associated with the user, information about a generalized parameter entered by the user via the user interface, the generalized parameter related to a preference of the user that applies across multiple types of items. Responsive to receiving the information about the generalized parameter, the online system 140 may include (e.g., via the data collection module 200) the generalized parameter into the set of generalized parameters.

The online system 140 receives 410 (e.g., via the order management module 220), via a network (e.g., the network 130) and from a device associated with the user (e.g., the user client device 100), a request for one or more items of an order. Responsive to the request, the online system 140 identifies 415 (e.g., via the order management module 220) that a replacement is needed for an item of the one or more items. Responsive to identifying that the replacement is needed, the online system 140 identifies 420 (e.g., via the replacement module 260), using information about the user and information about the item, a first set of one or more candidate replacement items for replacing the item. The online system 140 may retrieve (e.g., via the replacement module 260), from the database and using an identifier of the user, the information about the user including information about one or more specific parameters for the user, each of the one or more specific parameters related to a preference of the user for a specific type of item. The online system 140 may retrieve (e.g., via the replacement module 260), from the database and using an identifier of the item, the information about the item including information about a type (e.g., taxonomy or classification) of the item.

Responsive to identifying that the replacement is needed, the online system 140 generates 425 (e.g., via the prompting module 250) a first prompt for input into a generative machine-learning model (e.g., language model or LLM), the first prompt including one or more generalized parameters from the set of generalized parameters that are relevant to the item. The online system 140 requests 430 (e.g., via the prompting module 250) the generative machine-learning model to generate, based on the first prompt, a first response including a second set of one or more candidate replacement items for replacing the item. The online system 140 may generate (e.g., via the prompting module 250) another prompt for input into the generative machine-learning model, the prompt including the information about the item and the set of generalized parameters. The online system 140 may request (e.g., via the prompting module 250) the generative machine-learning model to generate, based on the other prompt input into the generative machine-learning model, a response including the one or more generalized parameters that are identified as being relevant to the item.

The online system 140 combines 435 (e.g., via the replacement module 260) the first set of one or more candidate replacement items and the second set of one or more candidate replacement items to generate a set of candidate replacement items. The online system 140 generates 440 (e.g., via the replacement module 260), using information about past ordering of items by the user, a score for each candidate replacement item from the set of candidate replacement items that is indicative of a likelihood of the user converting on each candidate replacement item. The online system 140 may apply a replacement machine-learning model (e.g., via the replacement module 260) to data including the information about past ordering of items by the user to generate the score for each candidate replacement item from the set of candidate replacement items.

The online system 140 may retrieve (e.g., via the machine-learning training module 230), from the database, information about replacements that a set of users of the online system 140 conducted while ordering items via the online system 140. The online system 140 may generate (e.g., via the machine-learning training module 230) a plurality of labels, each of the plurality of labels including an identifier of a missing item and an identifier of a replacement item that a user from the set of users converted instead of the missing item. The online system 140 may train (e.g., via the machine-learning training module 230), using training data including the plurality of labels, the replacement machine-learning model to generate a set of initial values for a set of parameters of the replacement machine-learning model.

The online system 140 may receive (e.g., at the machine-learning training module 230), via the network and from the device associated with the user, a user feedback signal indicating a response provided by the user via the user interface in relation to the replacement item. The online system 140 may re-train the replacement machine-learning model by updating (e.g., via the machine-learning training module 230), using the user feedback signal, the set of parameters of the replacement machine-learning model.

The online system 140 generates 445 (e.g., via the prompting module 250) a second prompt for input into the generative machine-learning model, the second prompt including information about each candidate replacement item from the set of candidate replacement items, the score for each candidate replacement item, and the one or more generalized parameters. The online system 140 requests 450 (e.g., via the prompting module 250) the generative machine-learning model to generate, based on the second prompt, a second response including an adjusted score for each candidate replacement item from the set of candidate replacement items, the adjusted score for each candidate replacement item representing an adjusted value of the score for each candidate replacement item.

The online system 140 may receive (e.g., at the prompting module 250), via the network and from the device associated with the user, one or more images (e.g., taken via the user client device 100 or a smart refrigerator owned by the user) with information about a current inventory of the user in relation to a set of items. The online system 140 may receive (e.g., at the prompting module 250), via the network and from the device associated with the user, information about a current weather. The online system 140 may retrieve (via the prompting module 250), from the database, the information about past ordering of items by the user. The online system 140 may include (via the prompting module 250) in the second prompt at least one of the information about the current inventory of the user, the information about the current weather, or the information about past ordering of items by the user.

The online system 140 selects 455 (e.g., via the selection module 270), using the adjusted score for each candidate replacement item, a replacement item from the set of candidate replacement items. The online system 140 may rank (e.g., via the selection module 270), using the adjusted score for each candidate replacement item, each candidate replacement item from the set of candidate replacement items to generate a ranked list of candidate replacement items. The online system 140 may select (e.g., via the selection module 270) the replacement item having a highest adjusted score among all adjusted scores of all candidate replacement items from the ranked list.

The online system 140 generates 460 (e.g., via the content presentation module 210), using information about the replacement item, a user interface signal. The online system 140 sends 465 (e.g., via the content presentation module 210), via the network, the user interface signal to the device associated with the user, wherein the sending the user interface signal causes the device associated with the user to display a user interface with the information about the replacement item and a user interface element. Selection of the user interface element (e.g., by the user) may trigger addition of the replacement item to the order instead of the item.

The online system 140 may receive (e.g., at the model serving system 150), via the network and from the device associated with the user, a user feedback signal indicating a response provided by the user via the user interface in relation to the replacement item. The online system 140 may retune (e.g., via the model serving system 150) the generative machine-learning model using the user feedback signal.

Embodiments of the present disclosure are directed to the online system 140 that uses a natural language processing and a generative machine-learning model (e.g., language model or LLM) to infer generalized parameters (or general replacement preferences) for a user and identify item replacements for the user based on the general replacement preferences. A general replacement preference is an item replacement preference for a given user that applies across multiple types of items, i.e., the general replacement preference is not related to just a specific item. A general replacement preference for a user of the online system 140 inferred by the generative machine-learning model can be used by a trained machine-learning model and/or the generative machine-learning model to find candidate replacement items for replacing a missing item, as well as to score and select one or more replacement items for recommendation to the user to replace the missing item.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
obtaining a set of generalized parameters for a user of an online system, each generalized parameter from the set of generalized parameters related to a preference of the user that applies across multiple corresponding types of items;
receiving, via a network and from a device associated with the user, a request for one or more items of an order;
responsive to the request, identifying that a replacement is needed for an item of the one or more items;
responsive to identifying that the replacement is needed, identifying, using information about the user and information about the item, a first set of one or more candidate replacement items for replacing the item;
responsive to identifying that the replacement is needed, generating a first prompt for input into a generative machine-learning model, the first prompt including one or more generalized parameters from the set of generalized parameters that are relevant to the item;
requesting the generative machine-learning model to generate, based on the first prompt, a first response including a second set of one or more candidate replacement items for replacing the item;
combining the first set of one or more candidate replacement items and the second set of one or more candidate replacement items to generate a set of candidate replacement items;
generating, using information about past ordering of items by the user, a score for each candidate replacement item from the set of candidate replacement items that is indicative of a likelihood of the user converting on each candidate replacement item;
generating a second prompt for input into the generative machine-learning model, the second prompt including information about each candidate replacement item from the set of candidate replacement items, the score for each candidate replacement item, and the one or more generalized parameters;
requesting the generative machine-learning model to generate, based on the second prompt, a second response including an adjusted score for each candidate replacement item from the set of candidate replacement items, the adjusted score for each candidate replacement item representing an adjusted value of the score for each candidate replacement item;
selecting, using the adjusted score for each candidate replacement item, a replacement item from the set of candidate replacement items;
generating, using information about the replacement item, a user interface signal; and
sending, via the network, the user interface signal to the device associated with the user, wherein the sending the user interface signal causes the device associated with the user to display a user interface with the information about the replacement item and a user interface element, and wherein selection of the user interface element triggers addition of the replacement item to the order instead of the item.

2. The method of claim 1, wherein obtaining the set of generalized parameters comprises:
retrieving, from a database of the online system, information about one or more specific parameters for the user, each of the one or more specific parameters related to a preference of the user for a specific type of item;
generating a third prompt for input into the generative machine-learning model, the third prompt including the one or more specific parameters and a request to infer a generalized parameter for the user that is related to a preference of the user that applies across a plurality of types of items;
requesting the generative machine-learning model to generate, based on the third prompt, a third response including the generalized parameter;
generating, using information about the generalized parameter, a second user interface signal;
sending, via the network, the second user interface signal to the device associated with the user, wherein the sending the second user interface signal causes the device associated with the user to display the user interface with the information about the generalized parameter and a notification for the user to confirm the generalized parameter;
receiving, via the network and from the device associated with the user, a confirmation signal indicating confirmation by the user of the generalized parameter; and
responsive to receiving the confirmation signal, including the generalized parameter into the set of generalized parameters.

3. The method of claim 1, wherein obtaining the set of generalized parameters comprises:
receiving, via the network and from the device associated with the user, information about a generalized parameter entered by the user via the user interface, the generalized parameter related to a preference of the user that applies across a plurality of types of items; and
responsive to receiving the information about the generalized parameter, including the generalized parameter into the set of generalized parameters.

4. The method of claim 1, further comprising:
retrieving, from a database of the online system and using an identifier of the user, the information about the user including information about one or more specific parameters for the user, each of the one or more specific parameters related to a preference of the user for a specific type of item; and
retrieving, from the database and using an identifier of the item, the information about the item including information about a type of the item.

5. The method of claim 1, further comprising:
generating a third prompt for input into the generative machine-learning model, the third prompt including the information about the item and the set of generalized parameters; and
requesting the generative machine-learning model to generate, based on the third prompt, a third response including the one or more generalized parameters that are identified as being relevant to the item.

6. The method of claim 1, wherein generating the score for each candidate replacement item comprises:
applying a replacement machine-learning model to data including the information about past ordering of items by the user to generate the score for each candidate replacement item from the set of candidate replacement items.

7. The method of claim 6, further comprising:
retrieving, from a database of the online system, information about replacements that a set of users of the online system conducted while ordering items via the online system;
generating a plurality of labels, each of the plurality of labels including an identifier of a missing item and an identifier of a replacement item that a user from the set of users converted instead of the missing item; and
training, using training data including the plurality of labels, the replacement machine-learning model to generate a set of initial values for a set of parameters of the replacement machine-learning model.

8. The method of claim 6, further comprising:
receiving, via the network and from the device associated with the user, a user feedback signal indicating a response provided by the user via the user interface in relation to the replacement item; and
re-training the replacement machine-learning model by updating, using the user feedback signal, a set of parameters of the replacement machine-learning model.

9. The method of claim 1, wherein generating the second prompt comprises:
receiving, via the network and from the device associated with the user, one or more images with information about a current inventory of the user in relation to a set of items;
receiving, via the network and from the device associated with the user, information about a current weather;
retrieving, from a database of the online system, the information about past ordering of items by the user; and
including in the second prompt at least one of the information about the current inventory of the user, the information about the current weather, or the information about past ordering of items by the user.

10. The method of claim 1, wherein selecting the replacement item comprises:
ranking, using the adjusted score for each candidate replacement item, each candidate replacement item from the set of candidate replacement items to generate a ranked list of candidate replacement items; and
selecting the replacement item having a highest adjusted score among all adjusted scores of all candidate replacement items from the ranked list.

11. The method of claim 1, further comprising:
receiving, via the network and from the device associated with the user, a user feedback signal indicating a response provided by the user via the user interface in relation to the replacement item; and
retuning the generative machine-learning model using the user feedback signal.

12. A computer program product comprising a non-transitory computer readable storage medium having instructions encoded thereon that, when executed by a processor, cause the processor to perform steps comprising:
obtaining a set of generalized parameters for a user of an online system, each generalized parameter from the set of generalized parameters related to a preference of the user that applies across multiple corresponding types of items;
receiving, via a network and from a device associated with the user, a request for one or more items of an order;
responsive to the request, identifying that a replacement is needed for an item of the one or more items;
responsive to identifying that the replacement is needed, identifying, using information about the user and information about the item, a first set of one or more candidate replacement items for replacing the item;
responsive to identifying that the replacement is needed, generating a first prompt for input into a generative machine-learning model, the first prompt including one or more generalized parameters from the set of generalized parameters that are relevant to the item;
requesting the generative machine-learning model to generate, based on the first prompt, a first response including a second set of one or more candidate replacement items for replacing the item;
combining the first set of one or more candidate replacement items and the second set of one or more candidate replacement items to generate a set of candidate replacement items;
generating, using information about past ordering of items by the user, a score for each candidate replacement item from the set of candidate replacement items that is indicative of a likelihood of the user converting on each candidate replacement item;
generating a second prompt for input into the generative machine-learning model, the second prompt including information about each candidate replacement item from the set of candidate replacement items, the score for each candidate replacement item, and the one or more generalized parameters;
requesting the generative machine-learning model to generate, based on the second prompt, a second response including an adjusted score for each candidate replacement item from the set of candidate replacement items, the adjusted score for each candidate replacement item representing an adjusted value of the score for each candidate replacement item;
selecting, using the adjusted score for each candidate replacement item, a replacement item from the set of candidate replacement items;
generating, using information about the replacement item, a user interface signal; and
sending, via the network, the user interface signal to the device associated with the user, wherein the sending the user interface signal causes the device associated with the user to display a user interface with the information about the replacement item and a user interface element, and wherein selection of the user interface element triggers addition of the replacement item to the order instead of the item.

13. The computer program product of claim 12, wherein the instructions further cause the processor to perform steps comprising:
retrieving, from a database of the online system, information about one or more specific parameters for the user, each of the one or more specific parameters related to a preference of the user for a specific type of item;
generating a third prompt for input into the generative machine-learning model, the third prompt including the one or more specific parameters and a request to infer a generalized parameter for the user related to a preference of the user that applies across a plurality of types of items;
requesting the generative machine-learning model to generate, based on the third prompt, a third response including the generalized parameter;
generating, using information about the generalized parameter, a second user interface signal;
sending, via the network, the second user interface signal to the device associated with the user, wherein the sending the second user interface signal causes the device associated with the user to display the user interface with the information about the generalized parameter and a notification for the user to confirm the generalized parameter;
receiving, via the network and from the device associated with the user, a confirmation signal indicating confirmation by the user of the generalized parameter; and
responsive to receiving the confirmation signal, obtaining the set of generalized parameters by including the generalized parameter into the set of generalized parameters.

14. The computer program product of claim 12, wherein the instructions further cause the processor to perform steps comprising:
retrieving, from a database of the online system and using an identifier of the user, the information about the user including information about one or more specific parameters for the user, each of the one or more specific parameters related to a preference of the user for a specific type of item; and
retrieving, from the database and using an identifier of the item, the information about the item including information about a type of the item.

15. The computer program product of claim 12, wherein the instructions further cause the processor to perform steps comprising:
generating a third prompt for input into the generative machine-learning model, the third prompt including the information about the item and the set of generalized parameters; and
requesting the generative machine-learning model to generate, based on the third prompt, a third response including the one or more generalized parameters that are identified as being relevant to the item.

16. The computer program product of claim 12, wherein the instructions further cause the processor to perform steps comprising:
applying a replacement machine-learning model to data including the information about past ordering of items by the user to generate the score for each candidate replacement item from the set of candidate replacement items.

17. The computer program product of claim 16, wherein the instructions further cause the processor to perform steps comprising:
retrieving, from a database of the online system, information about replacements that a set of users of the online system conducted while ordering items via the online system;
generating a plurality of labels, each of the plurality of labels including an identifier of a missing item and an identifier of a replacement item that a user from the set of users converted instead of the missing item;
training, using training data including the plurality of labels, the replacement machine-learning model to generate a set of initial values for a set of parameters of the replacement machine-learning model;
receiving, via the network and from the device associated with the user, a user feedback signal indicating a response provided by the user via the user interface in relation to the replacement item; and
re-training the replacement machine-learning model by updating, using the user feedback signal, the set of parameters of the replacement machine-learning model.

18. The computer program product of claim 12, wherein the instructions further cause the processor to perform steps comprising:
receiving, via the network and from the device associated with the user, one or more images with information about a current inventory of the user in relation to a set of items;
receiving, via the network and from the device associated with the user, information about a current weather;
retrieving, from a database of the online system, the information about past ordering of items by the user; and
generating the second prompt by including in the second prompt at least one of the information about the current inventory of the user, the information about the current weather, or the information about past ordering of items by the user.

19. The computer program product of claim 12, wherein the instructions further cause the processor to perform steps comprising:
receiving, via the network and from the device associated with the user, a user feedback signal indicating a response provided by the user via the user interface in relation to the replacement item; and
retuning the generative machine-learning model using the user feedback signal.

20. A computer system comprising:
a processor; and
a non-transitory computer-readable storage medium having instructions that, when executed by the processor, cause the computer system to perform steps comprising:
obtaining a set of generalized parameters for a user of an online system, each generalized parameter from the set of generalized parameters related to a preference of the user that applies across multiple corresponding types of items;
receiving, via a network and from a device associated with the user, a request for one or more items of an order;
responsive to the request, identifying that a replacement is needed for an item of the one or more items;
responsive to identifying that the replacement is needed, identifying, using information about the user and information about the item, a first set of one or more candidate replacement items for replacing the item;
responsive to identifying that the replacement is needed, generating a first prompt for input into a generative machine-learning model, the first prompt including one or more generalized parameters from the set of generalized parameters that are relevant to the item;
requesting the generative machine-learning model to generate, based on the first prompt, a first response including a second set of one or more candidate replacement items for replacing the item;
combining the first set of one or more candidate replacement items and the second set of one or more candidate replacement items to generate a set of candidate replacement items;
generating, using information about past ordering of items by the user, a score for each candidate replacement item from the set of candidate replacement items that is indicative of a likelihood of the user converting on each candidate replacement item;
generating a second prompt for input into the generative machine-learning model, the second prompt including information about each candidate replacement item from the set of candidate replacement items, the score for each candidate replacement item, and the one or more generalized parameters;
requesting the generative machine-learning model to generate, based on the second prompt, a second response including an adjusted score for each candidate replacement item from the set of candidate replacement items, the adjusted score for each candidate replacement item representing an adjusted value of the score for each candidate replacement item;
selecting, using the adjusted score for each candidate replacement item, a replacement item from the set of candidate replacement items;
generating, using information about the replacement item, a user interface signal; and
sending, via the network, the user interface signal to the device associated with the user, wherein the sending the user interface signal causes the device associated with the user to display a user interface with the information about the replacement item and a user interface element, and wherein selection of the user interface element triggers addition of the replacement item to the order instead of the item.
